(19) United States
(12) Patent Application Publication
(10) Pub. No.: US 2002/0102005 A1
(43) Pub. Date: Aug. 1, 2002

(54) Wireless hanging type earphone structure

(76) Inventor: Jiu-Lin Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/769,476

(22) Filed: Jan. 26, 2001

(51) Int. Cl. H04R 25/00

(52) U.S. Cl. 381/381; 381/375

(57) ABSTRACT

A wireless hanging type earphone structure comprises an upper casing, a lower casing, a circuit board, a battery, a microphone gooseneck, a microphone and a hook. A circuit board, comprising a circuit of receiving and transmitting signals, a wireless antenna, a speaker and a gleaming component, is set between the upper and lower casings; a battery is able to be turned to buckle into a groove of the top upper casing to support power; a gooseneck sets a microphone in the front side so as to adjust to search for an orientation in communication on the basis of bending characteristic of the gooseneck; a hook is buckled into a circular groove of the upper casing to form a container between the hook and the upper casing so as to wear by clipping the hook and a holding portion to fix on user's ear by resilience of the hook.

### FIELD OF THE INVENTION

The present invention relates to a wireless hanging type earphone structure and especially to a hanging type earphone with fine and delicate structure so that it is compact and thus can be carried conveniently and worn for a long time.

### DESCRIPTION OF THE PRIOR ART

With the advanced technology of communication and information to develop the personal outfit, mobile phone can use to communicate anywhere while driving or working. However, under the confinement of Law, the driver is not allowed to communicate by holding a mobile phone during driving. Therefore, there are many products of wireless hanging type earphone being produced in various forms or functions. Whereas, most products put emphases on the function to neglect the weight, size and comfort so it would cause a pain in user's ear after long-term use.

Therefore, there are many defects in the prior art which are necessary to be improved.

### SUMMERY OF THE INVENTION

Accordingly, the primary object of the present invention is to provide a wireless hanging type earphone with fine and delicate structure in human engineering of arc design as ear shape for users to wear.

Another object of the present invention is to provide a wireless hanging type earphone structure, in which the microphone is set in the front side of microphone gooseneck so as to adjust to search for an orientation in communication on the basis of bending characteristic of gooseneck.

A further object of the present invention is to provide a wireless hanging type earphone structure, in which the two transparent apertures are respectively on the casings and the front side of microphone to offer the function of incoming signal display so as to notify the user.

A still object of the present invention is to provide a wireless hanging type earphone structure, in which the battery is a rechargeable to reduce the environment pollution problems.

To achieve the objects, the present invention provides a wireless hanging type earphone structure composed of:

an upper casing including a groove in its top to load the battery; a transparent aperture beside the groove used to be conscious of gleaming; a circular groove and a holding portion beside the transparent aperture so the circular groove used to be buckled by a hook and a gooseneck; the holding portion used to bolster the inner top part of user's ear;

y a lower ccassiinng in which a circuit board fixed above and a speaker set underneath; through the a plurality of holes on the lower casing to transmit signals to user; the soft sponge wrapping around the lower casing to make useerr comfo comprising a circuit of receiving and transmitting the signals, a wireless antenna, a speaker and a gleaming component;

a battery turned to buckle into the groove of the top upper casing to support the power;

a microphone gooseneck which front side sets a microphone so as to adjust to search for an orientation in communication on the basis of bending characteristic of gooseneck;

a hook buckled into the circular groove of the upper casing to form a container between the hook and the upper casing to wear and clip to fix on the user's ear by the resilience of the hook.

The various objects and advantages of the present invention will be more readily understood from the following detailed description when read in conjunction with the appended drawing.

### BRIEF DESCRIPTION OF THE DRAWINGS

FIG. 1 is a stereoscopic view of the wireless hanging type earphone according to the present invention

FIG. 2 is an exploded schematic view of the wireless hanging type earphone according to the present invention

FIG. 3 is an embodiment schematic view of the wireless hanging type earphone according to the present invention

### DETAILED DESCRIPTION OF THE PREFERRED EMBODIMENT

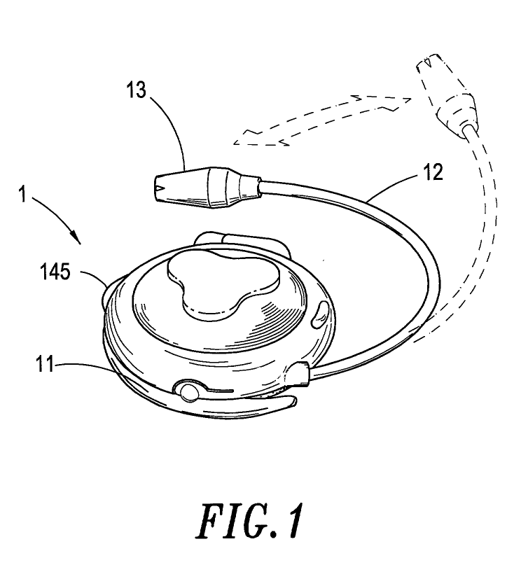

Referring to FIG. 1, the wireless hanging type earphone structure of the present invention is illustrated as a stereoscopic view. With fine and delicate earphone 1, in which the hook 11 is in human engineering of arc design as ear shape to correlate with the use of holding portion 145 so that the hanging type earphone 1 is able to fix on the user's ear; the microphone is set in the container 13 of the front side of microphone gooseneck 12 so as to adjust to search for an orientation in communication on the basis of bending characteristic of gooseneck 12.

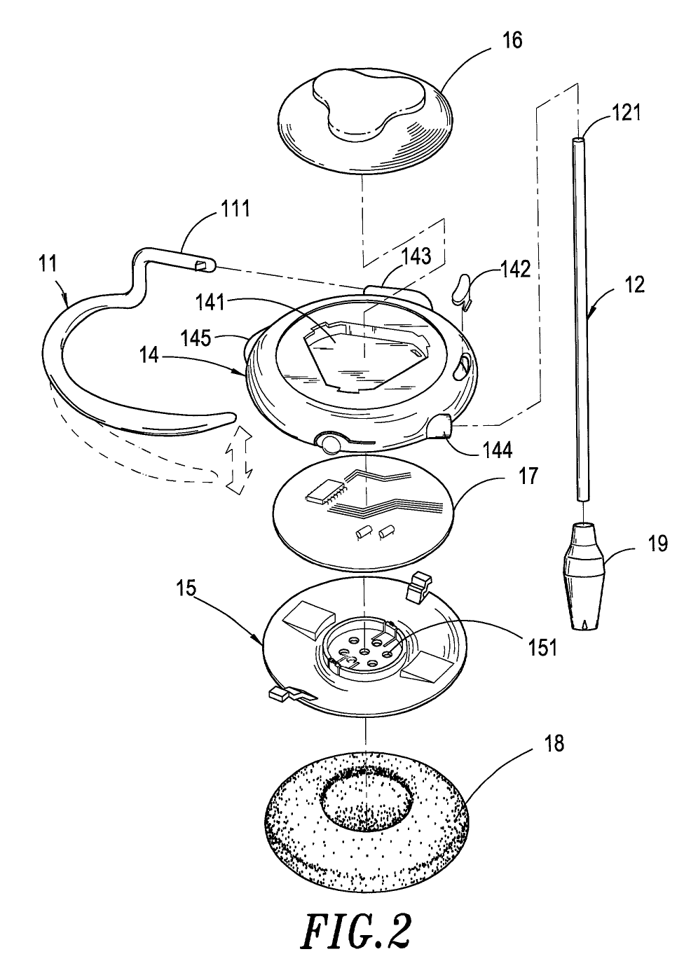

Referring to FIG. 2, the wireless hanging type earphone structure of the present invention is illustrated as an exploded schematic view; the present invention comprises:

an upper casing 14 including a groove 141 in its top to load the battery 16; a transparent aperture 142 beside the groove 141 used to be conscious of gleaming; two circular grooves 143, 144 and a holding portion 145 beside the transparent aperture so the two circular grooves 143, 144 used to be buckled by a hook 11 and a gooseneck 12; the holding portion 145 used to bolster the inner top part of user's ear;

a lower casing 15 in which a circuit board 17 fixed above and a speaker set underneath; through the a plurality of holes 151 on the lower casing 15 to transmit signals to user; the soft sponge 18 wrapping around the lower casing 15 to make user comfortable while wearing;

a circuit board 17 which is fixed between the two lobes of casings 14, 15 comprising a circuit of receiving and transmitting the signals, a wireless antenna, a speaker and a gleaming component;

a battery 16 turned to buckle into the groove 141 of the top upper casing 14 supporting the power.

a microphone gooseneck 12 which top side 121 linking up with the circular groove 144 of the upper casing 14, the bottom side 122 having a container 19 set a microphone so as to adjust to search for an orientation in communication on the basis of bending characteristic of gooseneck 12; besides setting microphone, a gleaming component being used as a notification of the incoming signal display.

a front section 111 of the hook 11 buckled into the circular groove 143 of the upper casing 14 to form a container between the hook 11 and the upper casing.

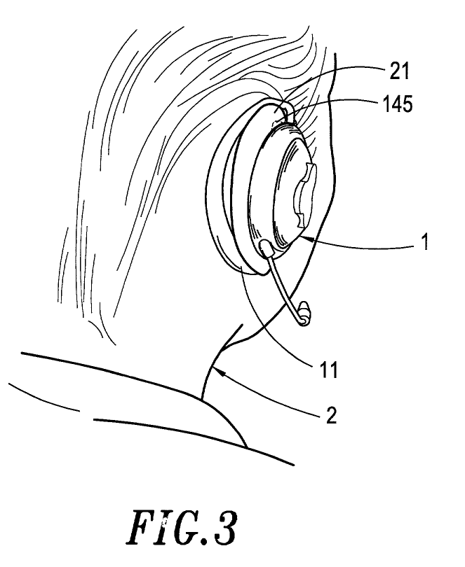

Referring to FIG. 3, the wireless hanging type earphone structure of the present invention is illustrated as an embodiment schematic view. When the user 2 wears the wireless hanging type earphone 1 on the ear 21, the hook 11 is hung to the ear back of the user 2 with the holding portion 145 clipping to fix on the ear 21 of the user 2 by the resilience of the hook.

Comparing the other prior arts wireless hanging type earphone with the present invention, the merits of the present invention are following:

1. The present invention is to provide a wireless hanging type earphone with fine and delicate structure in human engineering of arc design as ear shape for users to wear.

2. The present invention is to provide a wireless hanging type earphone structure, in which the microphone is set in the front side of microphone gooseneck so as to adjust to search for an orientation in communication on the basis of bending characteristic of gooseneck.

3. The present invention is to provide a wireless hanging type earphone structure, in which the two transparent apertures are respectively on the casings and the front side of microphone to offer the function of incoming signal display so as to notify the user.

4. The present invention is to provide a wireless hanging type earphone structure, in which the battery is a rechargeable to reduce the environment pollution problems.

5. The present invention is to provide a wireless hanging type earphone structure, in which the hided antenna reduces the weight and the size of the earphone.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. a wireless hanging type earphone structure composed of:
an upper casing including a groove in its top to load a battery; a circular groove and a holding portion beside so said circular groove used to be buckled by a hook and a gooseneck; said holding portion used to bolster inner top part of user's ear;
a lower casing in which a circuit board fixed above; through a plurality of holes on said tower casing to transmit signals;
said battery turned to buckle into said groove of top said upper casing to support power;
said gooseneck wherein a top side engages in said circular groove of said upper casing and a bottom side includes a container which sets a microphone so as to adjust to search for an orientation in communication on the basis of bending characteristic of said gooseneck;
said hook buckled into said circular groove of said upper casing to form said container between said hook and said upper casing;
so as to wear by clipping said hook and said holding portion to fix on user's ear by resilience of said hook;

2. the wireless hanging type earphone structure as claimed in claim 1, a transparent aperture setting beside said groove to be used as being conscious of gleaming;

3. the wireless hanging type earphone structure as claimed in claim 1, a soft sponge wrapping outside said plurality of holes to make user comfortable while wearing;

4. the wireless hanging type earphone structure as claimed in claim 1, said circuit board comprising a circuit of receiving and transmitting signals, a wireless antenna, a speaker and a gleaming component;

5. the wireless hanging type earphone structure as claimed in claim 1, besides setting said microphone, said gleaming component being used as a notification of incoming signal display.
